(19) United States
(12) Patent Application Publication
(10) Pub. No.: US 2014/0348300 A1
(43) Pub. Date: Nov. 27, 2014

(54) APPARATUS, METHOD AND NON-TRANSITORY COMPUTER-READABLE MEDIUM FOR DETECTING X-RAYS

(71) Applicant: Samsung Display Co., Ltd., Yongin-City (KR)

(72) Inventor: Dong-Hun LEE, Yongin-City (KR)

(73) Assignee: Samsung Display Co., Ltd., Yongin-City (KR)

(21) Appl. No.: 14/174,785

(22) Filed: Feb. 6, 2014

(30) Foreign Application Priority Data
May 23, 2013 (KR) 10-2013-0058557

(51) Int. Cl. H04N 5/32; G01T 1/16

(52) U.S. Cl. CPC H04N 5/32; G01T 1/16
USPC 378/98.2

(57) ABSTRACT

An X-ray detecting device and a method of determining X-ray image quality are presented. The X-ray detecting device includes a panel unit configured to receive X-rays coming from an inspection object and output a video signal for a plurality of unit detecting regions according to incident intensity levels of the X-rays. The device also includes an image quality determination unit configured to divide a plurality of unit detecting regions into an object region and a background region of a unit image according to brightness of a video signal, categorizing image quality of the unit image according to a size of a contrast-to-noise ratio of the video signal corresponding to the object region, and outputting a state signal corresponding to the categorization.

### CROSS-REFERENCE TO RELATED APPLICATION

This application claims priority to and the benefit of Korean Patent Application No. 10-2013-0058557 filed in the Korean Intellectual Property Office on May 23, 2013, the entire contents of which are incorporated herein by reference.

### BACKGROUND

(a) Field

This disclosure relates to a device and a method detecting X-rays. More particularly, this disclosure relates to a portable device for detecting X-rays that is capable of automatically reading image quality of an X-ray image.

(b) Description of the Related Art

X-ray is an electromagnetic wave of a short wavelength, and X-ray photography entails directing the electromagnetic wave to an inside of a subject by using a radiographic projection method of the X-ray. The X-ray is attenuated according to the density or thickness of the subject as the X-ray passes through the subject. Accordingly, the X-ray photography displays the projected image with a gray scale of a plane for the inside of the subject based on the attenuation amount experienced by the X-ray as it is transmitted through the subject. An X-ray photography system comprises an X-ray irradiation device generating the X-ray waves and irradiating the subject and an X-ray detecting device disposed to face the X-ray irradiation device on the other side of the subject from the X-ray irradiation device. The X-ray detecting device detects the attenuation amount of the X-ray.

Currently, the X-ray detecting device mainly uses a digital radiography method in which a film is not used. The digital radiography method arranges a plurality of light detecting pixels sensing the X-ray with an approximate matrix format and obtains an electrical signal for each light detecting pixel corresponding to the incident amount of the X-ray to be processed into a digital video signal. Accordingly, the digital radiography method comprises a signal processing device reading and converting the electrical signal of the light detecting pixel into a digital video signal and a display device (e.g., a monitor) to display the video signal to a user. The signal processing device and the monitor may be formed of a user terminal such as a personal computer (PC).

In the above X-ray photography system, a connection between the devices is integrally formed by a wire such that portability is limited. Such hard wiring restricts spatial separation during usage: for example, the X-ray irradiation device and the X-ray detecting device are positioned in one space (photographing space), and a detector operating the user terminal is positioned in another space (the detection space).

Also, since the detector directly evaluates the contrast level of the image through the monitor to determine whether the corresponding image is suitable to be used for a diagnosis, the detector is influenced by environmental variation such as the resolution of the monitor, a function of an image viewer program, and the skill level of technicians involved. Further, when an erroneous determination is made by the detector, the X-ray photography is repeated with an increased dose of radiation. Also, the amount of time it takes for the detector to evaluate the image displayed on the monitor is long.

### SUMMARY

One aspect of the inventive concept provides an X-ray detecting device that directly determines whether an X-ray image is of high enough quality to be suitable for diagnosis purposes. The device may be formed using a detector that is configured to automatically determine the image quality of an X-ray image and convey the quality to a user. The X-ray detecting device may be made portable.

An X-ray detecting device according to another aspect of the inventive concept comprises: a panel unit configured to receive X-rays coming from an inspection object and outputting a video signal for a plurality of unit detecting regions according to incident intensity levels of the X-rays; and an image quality determination unit configured to classify a plurality of unit detecting regions into an object region and a background region of a unit image according to brightness of the video signal, categorizing an image quality of the unit image according to a size of a contrast-to-noise ratio of the video signal corresponding to the object region, and outputting a state signal corresponding to the categorization.

At least one of the plurality of unit detecting regions may comprises a light detecting pixel sensing the X-rays to output as an electrical signal. The image quality determination unit may comprise: an image separation unit classifying the plurality of unit detecting regions into unit detecting regions corresponding to the object region and the background region of the unit image according to a brightness distribution of a plurality of unit detecting regions for brightness; a calculation unit receiving a video signal of the unit detecting regions corresponding to the object region and calculates a contrast-to-noise ratio of the transmitted video signal; and an indicator unit determining an image quality of the unit image according to the contrast-to-noise ratio to output the state signal.

The image separation unit may generate the distribution of a plurality of unit detecting regions as a histogram for the brightness, may select a threshold value that is useful for dividing the background region and the object region, and may apply the threshold value to the histogram to divide a plurality of unit detecting regions.

The image separation unit may classify plurality of unit detecting regions according to the contrast level difference between the center region and the peripheral area by setting a plurality of unit detecting regions as a center region and a plurality of peripheral areas with reference to the center region. An indicator unit may categorize the image quality of the X-ray image by using a middle value or an average value of the contrast-to-noise ratio.

An indicator unit displaying a state of the image quality of the unit image outside according to the state signal may be further comprised. The indicator unit may comprise a light emitting element or a speaker.

An X-ray detecting method according to an exemplary embodiment further comprises: receiving X-rays coming from an inspection object; outputting a video signal for a plurality of unit detecting regions, the video signal correlating with incident intensity of the X-rays; classifying the plurality of unit detecting regions into an object region and a background region of a unit image according to brightness of the video signal; and categorizing image quality of the unit image according to contrast-to-noise ratio of the video signal corresponding to the object region and outputting a state signal corresponding to the categorization.

At least one of the plurality of unit detecting regions may comprise a light detecting pixel sensing the X-rays and is configured to output an electrical signal. The classifying of the object region and the background region of the unit image may comprise: generating a brightness distribution of a plurality of unit detecting regions as a histogram; selecting, using the histogram, a threshold value to divide the background region and the object region; and applying the threshold value to the histogram to perform the dividing.

In the classifying of the object region and the background region of the unit image, a plurality of unit detecting regions may be divided according to a contrast value difference between the center region and the peripheral area by setting a plurality of unit detecting regions as a center region and a plurality of peripheral areas with reference to the center region.

The categorizing of the image quality comprises using at least one of a middle value or an average value of the contrast-to-noise ratio. The method may further comprise conveying the image quality of the unit image according to the state signal.

An exemplary embodiment of the inventive concept relates to the X-ray detecting device and the method therefor, wherein the image quality of the image is automatically read and the read result is conveyed (visually and/or audibly) outside the device such that the user (detector) may immediately determine whether the corresponding image is suitable for the diagnosis image, thereby reducing the amount of time it takes to decide whether an image is of high enough quality.

Also, an exemplary embodiment determines the image quality of the image through numerical data such that any variation due to environmental factors may be minimized, thereby obtaining an objective result. Further, an exemplary embodiment prevents the need for repeated X-ray photographing due to an error on the part of the user (detector). Hence, incidents of unnecessary irradiation may be reduced.

In addition, an exemplary embodiment transmits/receives the data through the wireless communication between the X-ray detecting device and the user terminal such that a spatial limitation of the X-ray photographing space matters less.

### BRIEF DESCRIPTION OF THE DRAWINGS

FIG. 1 is a block diagram of an X-ray photography system according to an exemplary embodiment of the disclosure.

FIG. 2 is a detailed block diagram of an X-ray detecting device 200 shown in FIG. 1.

FIG. 3 is a detailed block diagram of an image quality determination unit 220 shown in FIG. 2.

FIG. 4 is a flowchart of an X-ray detecting method according to an exemplary embodiment of the disclosure.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Next, an exemplary embodiment will be described with reference to the accompanying drawings.

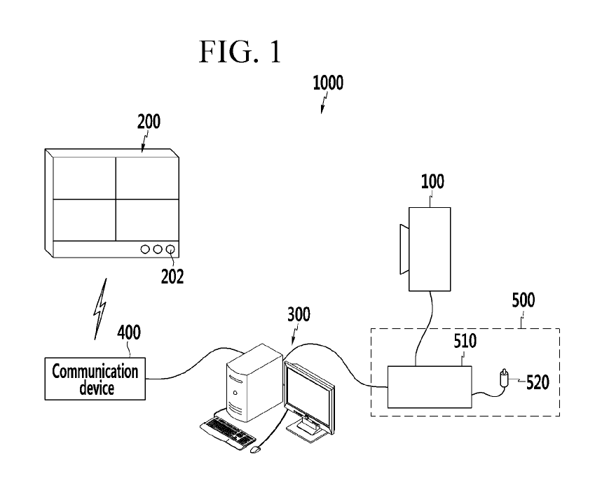

FIG. 1 is a block diagram of an X-ray photography system according to an exemplary embodiment.

Referring to FIG. 1, an X-ray photography system 1000 according to an exemplary embodiment comprises an X-ray irradiation device 100, an X-ray detecting device 200, a user terminal 300, a communication device 400, and an operation device 500. Here, the X-ray irradiation device 100 generates X-rays and directs the X-rays to an object that is being inspected (not shown). The object is positioned between the X-ray irradiation device 100 and the X-ray detecting device 200, and the X-ray irradiation device 100 is controlled by the operation device 500 such that the X-rays irradiate a predefined inspection region of the object.

The X-ray detecting device 200 receives the X-rays passing through the object and generates an electrical signal for each of a plurality of unit detecting regions according to an intensity of the incident X-rays. The X-ray detecting device 200 reads the electrical signal for each unit detecting region to convert and process the electrical signal into a digital video signal to be output. Each of the plurality of unit detecting regions includes a light detecting pixel, and a plurality of unit detecting regions are closely disposed in an approximate matrix format.

The X-ray detecting device 200 wirelessly communicates with the user terminal 300 to transmit the video signal to the user terminal 300. Here, it is preferable that the X-ray detecting device 200 receives power from a rechargeable battery (not shown). The X-ray detecting device 200 according to an exemplary embodiment is not hard-wired to the X-ray irradiation device 100 or the user terminal 300, and may be disposed separately from the user terminal 300. The X-ray detecting device 200 may be portable.

The X-ray detecting device 200 divides the video signal for one frame unit into a unit detecting region corresponding to an object and a background to extract an object video signal and a background video signal. Hereafter, the image corresponding to the video signal of one frame unit is referred to as a “unit image.” Also, the X-ray detecting device 200 calculates a contrast noise ratio of an object video signal, determines image quality of the unit image according to a size of the calculated contrast noise ratio, and outputs a state signal corresponding to the image quality.

The X-ray detecting device 200 according to an exemplary embodiment further comprises a plurality of user communication components (indicators) 202 driven according to the state signal. The user communication components 202 may be a visual indicator (e.g., a light) disposed on the outer surface of the X-ray detecting device 200 to indicate the image quality of the unit image. For example, the user communication components 202 may be a light emitting element, a speaker, an array of light emitting elements, or a combination of the above.

The user terminal 300 signal-processes the video signal transmitted from the X-ray detecting device 200 through the communication device 400 to display the video signal on a screen. Here, the user terminal 300 may be a PC (personal computer) or a laptop. The user terminal 300 generates a plurality of driving control signals controlling the X-ray detecting device 200 for wireless transmission through the communication device 400.

The communication device 400 is controlled by the user terminal 300 for the wireless communication with the X-ray detecting device 200. The communication device 400 according to an exemplary embodiment may communicate through a wireless LAN, which is a local wireless communication method. For example, IR (infra-red) communication, RF (radio frequency) communication, Bluetooth communication, Wi-Fi communication, or a wireless USB communication method may be used.

The operation device 500 is controlled by the user to control the X-ray irradiation device 100. The operation device 500 comprises a switching means 510 operated by the user and a switching control means 520 generating a switching signal according to an operation result of the switching means 510 and transmitting it to the X-ray irradiation device 100.

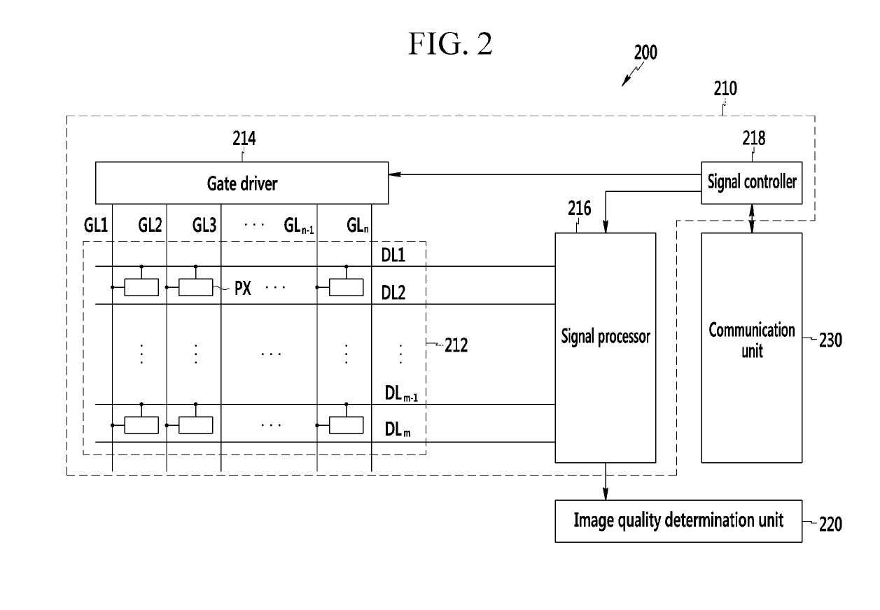

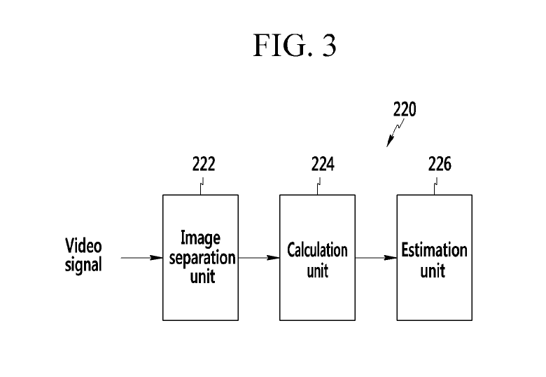

FIG. 2 is a detailed block diagram of an X-ray detecting device 200 shown in FIG. 1, and FIG. 3 is a detailed block diagram of an image quality determination unit 220 shown in FIG. 2.

Referring to FIG. 2, the X-ray detecting device 200 comprises a panel unit 210, an image quality determination unit 220, and a communication unit 230. The panel unit 210 comprises a flat panel 212, a gate driver 214, a signal processor 216, and a signal controller 218. The flat panel 212 comprises a plurality of unit detecting regions, thereby sensing the X-rays incident on each unit detecting region to output a plurality of electrical signals corresponding to the incident intensity of the X-rays. In one embodiment, each unit detecting region includes a light-detecting pixel PX formed at a crossing position of each gate line GL1-GLn and each data DL1-DLm. The light detecting pixel PX comprises a plurality of thin film transistors (TFTs), photo diodes (LDs), etc. A plurality of gate lines GL1-GLn and a plurality of data lines DL1-DLm are formed to be crossed, and the light detecting pixels PX are arranged in an approximate matrix format. In the flat panel 212, a scintillator layer (not shown) to convert the X-rays into visible rays may be formed at a surface on which the X-rays are incident.

The gate driver 214 is connected to a plurality of gate lines GL1-GLn and is controlled by the signal controller 218 thereby controlling the driving of a plurality of light detecting pixels PX. The signal processor 216 is connected to a plurality of data lines DL1-DLm and is controlled by the signal controller 218 thereby receiving and reading a plurality of electrical signals respectively output from the plurality of light detecting pixels PX and processing the plurality of electrical signals to be output as digital video signals.

For this, the signal processor 216 comprises a readout integrated circuit (not shown) reading the electrical signal and an analog-digital converter (not shown) converting the analog signal output from the readout integrated circuit into a digital signal. The signal controller 218 receives a driving control signal from the user terminal 300 to control the driving of the gate driver 214 and the signal processor 216. The signal controller 218 is in synchronization with the X-ray irradiation device 100, thereby controlling the driving of the gate driver 214 and the signal processor 216.

The image quality determination unit 220 receives the video signal from the signal processor 216 and classifies a plurality of unit detecting regions into an object region and a background region of the unit image according to brightness of the video signal. The image quality determination unit 220 separates the video signal into an object video signal and a background video signal corresponding to the object region and the background region. The image quality determination unit 220 calculates a contrast-to-noise ratio (CNR) of the object video signal and outputs a state signal that correlates with the image quality of the unit image according to the contrast-to-noise ratio.

In detail, the image quality determination unit 220 comprises an image separation unit 222, a calculation unit 224, and an estimation unit 226 as shown in FIG. 3. The image separation unit 222 generates a histogram for the video signal of the unit image. The image separation unit 222 initially sets the contrast level of the video signal at a predetermined range and generates a number of the unit detecting regions corresponding to each contrast value in the predetermined range to populate the histogram.

Using the histogram, the image separation unit 222 selects a threshold value to divide the background region and the object region of the unit image. The video signal is divided into the background video signal and the object video signal with reference to the selected threshold value.

Here, the image separation unit 222 may compute an average of the brightness value for the entire video signal to select the threshold value, or a predetermined brightness distribution ratio may be used to select the threshold value. Also, the image separation unit 222 may select a valley point, or the lowest point, of the brightness value distribution as the threshold value, for example when the histogram is generated with a two-ridge line shape.

The image separation unit 222 may divide the histogram into two classes with reference to the valley point and calculate a variance in the classes to extracts a minimum value (or a maximum value) of the variance in the class as the threshold value. Here, the variance in the class may be defined by a sum of a product of the variance of the first class and the first weight value, and a variance of the second class and the second weight value. Here, the first and second weight values represent a possibility that the pixel corresponding to each class appears in the entire X-ray image.

Meanwhile, an exemplary embodiment is not limited thereto, and the image separation unit 222 may divide the video signal into the background video signal and the object video signal by applying a local binary pattern (LBP) to a plurality of unit detecting regions. Here, the local binary pattern may be calculated by Equation 1 after setting the partial unit detecting region positioned at the center among a plurality of unit detecting regions as a center region (ic) and the rest of the unit detecting regions except for the center region (ic) as a plurality of peripheral areas (in).

$$LBP ( {i}_{c} ) = {\sum }_{n = 0}^{ } s ( {i}_{n} - {i}_{c} ) \times {2}^{n} \qquad ( Equation 1 )$$

Here, s(x) is a function having a value of 1 if x is equal to or larger than 0 and a function having a value of 0 in the remaining cases. The unit detecting region in which the value of s(x) is 1 corresponds to the object region, and the unit detecting region in which the value of s(x) is 0 corresponds to the background region. That is, the local binary pattern expresses the video signal as 1 or 0 by setting a plurality of unit detecting regions as the center region (ic) and a plurality of peripheral areas (in) with reference to the center region and by using the contrast difference between the center region (ic) and the peripheral area (in).

The calculation unit 224 receives the object video signal from the image separation unit 222 and calculates a contrast-to-noise ratio of the object video signal. Here, the contrast-to-noise ratio is defined by Equation 2.

CNR=C/σl (Equation 2)

Here, C is a contrast, and σl is a background reference deviation value. The σl corresponds to a value that a strength change value (Δ/l) is divided by a background strength average value(/l).

The estimation unit 226 estimates the image quality of the unit image according to the contrast-to-noise ratio through the calculation unit 224 and outputs the state signal corresponding to the estimation result. Here, the estimation unit 226 may estimate the image quality of the unit image by comparing the center (median) value or the average (mean) value of the contrast-to-noise ratio with a predetermined reference value.

For example, if the middle value of the contrast-to-noise ratio is higher than the predetermined reference value, it may be determined that the unit image is of an image quality that is suitable for the purpose of diagnosis. On the other hand, if the middle value is lower than the predetermined reference value, it may be determined that the unit image is of an image quality that is not suitable for diagnosis purposes. These are just exemplary embodiments and not limitations of the inventive concept. The reference value may be set as a plurality of operations or stages and it may be determined that the unit image is of an image quality that is suitable for purposes of diagnosis when the operation comprising the contrast-to-noise ratio is more than the middle step.

Again referring to FIG. 2, the communication unit 230 transmits and receives the video signal and the external control signal wirelessly. In detail, the communication unit 230 communicates with the user terminal 300 and transmits the video signal to the user terminal 300 according to the control of the user terminal 300. The communication unit 230 receives the control signal controlling the driving of the panel unit 210 from the user terminal 300.

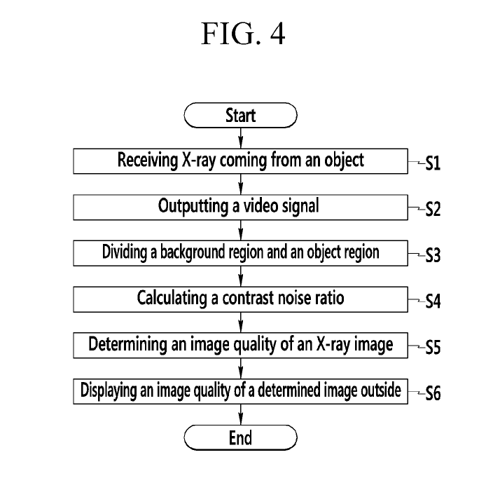

FIG. 4 is a flowchart of an X-ray detecting method according to an exemplary embodiment.

Referring to FIG. 4, if the object to be inspected is positioned between the X-ray irradiation device 100 and the X-ray detecting device 200 and preparation of the X-ray photography is completed, the X-ray irradiation device 100 irradiates the object in response to an input received from the operation device 500. The X-rays pass through the object and are received by the X-ray detecting device 200 (operation S1). Next, the X-rays incident on the X-ray detecting device 200 are converted into visible rays and a plurality of electrical signals are output for each unit detecting region according the incident amount of the converted visible rays. Thus, the signal processor 216 reads and processes a plurality of electrical signals to output the digital video signal (operation S2).

Next, the image separation unit 222 that has previously set the contrast of the video signal at a predetermined range generates a number of the unit detecting regions corresponding to each contrast value within the predetermined range with a histogram. The image separation unit 222 selects the threshold value using the histogram, and divides a plurality of unit detecting regions into the background region and the object region of the unit image with reference to the threshold value to divide the video signal into the background video signal and the object video signal (operation S3).

Next, the calculation unit 224 calculates the contrast-to-noise ratio of the object video signal (operation S4). Also, the estimation unit 226 calculates the middle value (or the average value) of the contrast-to-noise ratio and compares the contrast-to-noise ratio with the predetermined reference value. The image quality of the unit image is categorized according to the relative magnitudes of the contrast-to-noise ratio and the reference value (step S5). For example, when the contrast-to-noise ratio exceeds the reference value, the image quality of the unit image may be categorized as being suitable for diagnosis purposes. On the other hand, when the contrast-to-noise ratio is smaller than the reference value, the image quality of the unit image may be categorized as not being suitable for diagnosis. Also, the estimation unit 226 outputs a state signal according to the categorization. Thus, the user communication components 202 is operated according to the state signal such that the image quality of the unit image is indicated to the outside (operation S6).

For example, in operation S5, when the image quality of the unit image is high enough to be used for diagnosis, the indicator unit 226 may activate a state signal lighting a blue LED to indicate a high image quality. In contrast, when the image quality of the unit image is not suitable for diagnosis, the indicator unit 226 may activate a state signal lighting a red LED to indicate a low image quality.

In the X-ray detecting method according to an exemplary embodiment, before the user spends time visually reviewing the unit image displayed at the screen of the user terminal 300, the user checks the image quality of the corresponding unit image through the user communication component 202 (the indicator unit). When the corresponding unit image is indicated as having an image quality that is suitable for diagnosis, the user sends an instruction to the user terminal 300. When the image quality is indicated as not being suitable for diagnosis, the X-ray photography may be repeated by inputting an instruction through the operation device 500. Accordingly, whether an initial level of quality that is needed for diagnosis is there may be quickly confirmed through the user communication components 202 before the user spends more time reviewing the image.

Various embodiments of the present disclosure may be implemented in or involve one or more computer systems. The X-ray detecting device 200, for example, may incorporate a computer system. The computer system is not intended to suggest any limitation as to scope of use or functionality of described embodiments. The computer system includes at least one processing unit and memory. The processing unit executes computer-executable instructions and may be a real or a virtual processor. The computer system may include a multi-processing system which includes multiple processing units for executing computer-executable instructions to increase processing power. The memory may be volatile memory (e.g., registers, cache, random access memory (RAM)), non-volatile memory (e.g., read only memory (ROM), electrically erasable programmable read only memory (EEPROM), flash memory, etc.), or combination thereof. In an embodiment of the present disclosure, the memory may store software for implementing various embodiments of the present disclosure.

Further, the computer system may include components such as storage, one or more input computing devices, one or more output computing devices, and one or more communication connections. The storage may be removable or non-removable, and includes magnetic disks, magnetic tapes or cassettes, compact disc-read only memories (CD-ROMs), compact disc rewritables (CD-RWs), digital video discs (DVDs), or any other medium which may be used to store information and which may be accessed within the computer system. In various embodiments of the present disclosure, the storage may store instructions for the software implementing various embodiments of the present disclosure. The input computing device(s) may be a touch input computing device such as a keyboard, mouse, pen, trackball, touch screen, or game controller, a voice input computing device, a scanning computing device, a digital camera, or another computing device that provides input to the computer system. The output computing device(s) may be a display, printer, speaker, or another computing device that provides output from the computer system. The communication connection(s) enable communication over a communication medium to another computer system. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media includes wired or wireless techniques implemented with an electrical, optical, RF, infrared, acoustic, or other carrier. In addition, an interconnection mechanism such as a bus, controller, or network may interconnect the various components of the computer system. In various embodiments of the present disclosure, operating system software may provide an operating environment for software's executing in the computer system, and may coordinate activities of the components of the computer system.

Various embodiments of the inventive concept disclosed herein may be described in the general context of computer-readable media. Computer-readable media are any available media that may be accessed within a computer system. By way of example, and not limitation, within the computer system, computer-readable media include memory, storage, communication media, and combinations thereof.

Having described and illustrated the principles of the inventive concept with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

While this inventive concept has been described in connection with what is presently considered to be practical exemplary embodiments, it is to be understood that the concept is not limited to the disclosed embodiments but, on the contrary, is intended to cover various modifications and equivalent arrangements.

What is claimed is:

1. An X-ray detecting apparatus comprising:
a panel unit configured to receive X-rays coming from an inspection object and output a video signal for a plurality of unit detecting regions according to incident intensity levels of the X-rays; and
an image quality determination unit configured to classify the plurality of unit detecting regions into an object region and a background region of a unit image according to brightness of the video signal, categorizing an image quality of the unit image according to a contrast-to-noise ratio of the video signal corresponding to the object region, and outputting a state signal corresponding to the categorization.

2. The X-ray detecting apparatus of claim 1, wherein
At least one of the plurality of unit detecting regions comprises a light detecting pixel sensing the X-rays to output as an electrical signal.

3. The X-ray detecting apparatus of claim 1, wherein
the image quality determination unit comprises:
an image separation unit classifying the plurality of unit detecting regions into the object region and the background region of the unit image according to a brightness distribution of a plurality of unit detecting regions;
a calculation unit receiving a video signal of the unit detecting regions corresponding to the object region and calculates a contrast-to-noise ratio of the transmitted video signal; and
an indicator unit determining an image quality of the unit image according to the contrast-to-noise ratio to output the state signal.

4. The X-ray detecting apparatus of claim 3, wherein
the image separation unit generates the distribution of a plurality of unit detecting regions as a histogram for the brightness, selects a threshold value useful for dividing the background region and the object region, and applies the threshold value to the histogram to divide a plurality of unit detecting regions.

5. The X-ray detecting apparatus of claim 3, wherein
the image separation unit classifies a plurality of unit detecting regions according to the contrast level difference between the center region and the peripheral area by setting a plurality of unit detecting regions as a center region and a plurality of peripheral areas with reference to the center region.

6. The X-ray detecting apparatus of claim 3, wherein
the indicator unit categorizes the image quality of the X-ray image by using a middle value or an average value of the contrast-to-noise ratio.

7. The X-ray detecting apparatus of claim 1, further comprising
a user communication component conveying the image quality of the unit image according to the state signal.

8. The X-ray detecting apparatus of claim 7, wherein
the user communication component comprises at least one of a light emitting element and a speaker.

9. A method detecting an X-ray comprising:
receiving X-rays coming from an inspection object;
outputting a video signal for a plurality of unit detecting regions, the video signal correlating with incident intensity of the X-rays;
classifying the plurality of unit detecting regions into an object region and a background region of a unit image according to brightness of the video signal; and
categorizing image quality of the unit image according to a contrast-to-noise ratio of the video signal corresponding to the object region and outputting a state signal corresponding to the categorization.

10. The method of claim 9, wherein
at least one of the plurality of unit detecting regions comprises a light detecting pixel sensing the X-rays and is configured to output an electrical signal.

11. The method of claim 9, wherein
the classifying of the object region and the background region of the unit image comprises:
generating a brightness distribution of a plurality of unit detecting regions as a histogram;
selecting, using the histogram, a threshold value to divide the background region; and
applying the threshold value to the histogram to perform the dividing.

12. The method of claim 9, wherein
in the classifying of the object region and the background region of the unit image,
a plurality of unit detecting regions are divided according to a contrast value difference between the center region and the peripheral area by setting a plurality of unit detecting regions as a center region and a plurality of peripheral areas with reference to the center region.

13. The method of claim 9, wherein
the categorizing of the image quality comprises using at least one of a middle value and an average value of the contrast-to-noise ratio.

14. The method of claim 9, further comprising
conveying the image quality of the unit image according to the state signal.

15. A non-transitory computer-readable medium storing instructions that, when executed, cause a computer to perform a method for detecting an X-ray comprising:
receiving X-rays coming from an inspection object;
outputting a video signal for a plurality of unit detecting regions, the video signal correlating with incident intensity of the X-rays;
classifying the plurality of unit detecting regions into an object region and a background region of a unit image according to brightness of the video signal; and
categorizing image quality of the unit image according to a contrast-to-noise ratio of the video signal corresponding to the object region and outputting a state signal corresponding to the categorization.
